(19) United States
(12) Patent Application Publication
(10) Pub. No.: US 2015/0096558 A1
(43) Pub. Date: Apr. 9, 2015

(54) HELMET AIR PURIFICATION SYSTEM

(71) Applicant: David W. Mazyck, Gainesville, FL (US)

(72) Inventor: David W. Mazyck, Gainesville, FL (US)

(21) Appl. No.: 14/396,358

(22) PCT Filed: Apr. 23, 2013
(86) PCT No.: PCT/US13/37830

§ 371 Date: Oct. 22, 2014

Related U.S. Application Data
(60) Provisional application No. 61/637,133, filed on Apr. 23, 2012.

(51) Int. Cl. A62B 7/10

(52) U.S. Cl. CPC A62B 7/10
USPC 128/201.25

(57) ABSTRACT

A helmet with an integrated filter includes a helmet; a filter, integrated with the helmet, incorporating a woven mixture of fiber and particles, resulting in an intermediary material that combines the advantages of both the particle-based and fiber-based filters and has a low pressure drop and high adsorption capacity such that the filter captures gaseous contaminants.

### CROSS-REFERENCED TO RELATED APPLICATIONS

This application is a National Stage Application of PCT/US 13/37830 filed on Apr. 23, 2013, which claims the benefit of U.S. Provisional Application No. 61/637,133 filed on Apr. 23, 2012, both of which are incorporated by reference in their entirety.

### BACKGROUND

There is a need for racecar drivers to have cleaner air to breath during races and practice runs. There is the need for air filtration systems that are integrated into various types of helmets. Racecars are optimized to gain the maximum performance from their engines, and in an effort to reduce weight of the overall chassis pollution control devices such as catalytic convertors are often either removed or never installed. Furthermore, to gain maximum traction race tires are engineered to optimize grip, and often these tires are far softer compared to street tires. Every time a car accelerates, turns, and or brakes, the tires are wearing and emissions are released. Similarly, racecar brake pads are engineered to decrease acceleration, and when the brake pad is pressed against the rotor emissions are released. In summary, emissions from unburned fuel, lack of pollution control equipment, and emissions from tires and brake pads result in noxious fumes that can cause dizziness, light headiness, blurred vision, and possibly long-term health implications. Racecar drivers often easily exceed 100 MPH, and dizziness and/or light headiness can pose serious threats to themselves and other competitors. Although at possibly lower concentrations, the same threats posed to racecar drivers are present for any transit vehicle, and in some instances (e.g., aircraft) the overall threat could be far greater.

### BRIEF DESCRIPTION OF THE DRAWINGS

FIG. 1 shows one embodiment of a helmet with integrated filter; and

FIG. 2 shows a detailed view of the filter portion of FIG. 1.

### SUMMARY

In one embodiment, a helmet with integrated filter includes a helmet; a filter, integrated with the helmet, incorporating a woven mixture of fiber and particles, resulting in an intermediary material that combines the advantages of both the particle-based and fiber-based filters and has a low pressure drop and high adsorption capacity such that the filter captures gaseous contaminants. Optionally, the filter is located right before the helmet as compared to other locations in tubing leading to the helmet resulting in more uniform air flow because of a more laminar flow regime versus turbulent air flow regime when air first enters the tubing. In one configuration, the filter is doped with metals/catalysts that can convert NOx to N₂ and wherein the metals/catalysts are selected from a group consisting of copper, platinum, and palladium. Optionally, the fiber and particles of the woven mixture are directly connected linearly. In one alternative, the filter is configured to be regenerated by catalysts that create oxidizing agents when exposed to UV light. In another alternative, the catalysts are TiO₂ and regeneration is completed with 365 nm UV LEDs. Optionally, a distance between the LEDs and the filter is less than 1 inch for regeneration.

In another embodiment, a helmet with integrated filter includes a helmet add an air intake tube attached to the helmet. The helmet further includes a filter located in the air intake tube, the filter configured to remove impurities in air. Optionally, the air intake tube connects to the helmet at a first position and the filter is proximate to the first position. Alternatively, the filter position is configured to provide laminar flow to incoming air. In one configuration, the helmet is a racing helmet. In another configuration, the filter incorporates a woven mixture of fiber and particles, resulting in an intermediary material that combines the advantages of both the particle-based and fiber-based filters and has a low pressure drop and high adsorption capacity such that the filter filters for gaseous contaminants. Optionally, the filter is doped with metals/catalysts that can convert NOx to N₂ and the metals/catalysts are selected from a group consisting of copper, platinum, and palladium. Alternatively, the fiber and particles of the woven mixture are directly connected in a linear fashion. In one alternative, the filter is configured to be regenerated by catalysts that create oxidizing agents when exposed to UV light. Optionally, the catalysts are TiO₂ and regeneration is completed with 365 nm UV LEDs. Alternatively, a distance between the LEDs and the filter is less than 1 inch for regeneration.

In one embodiment, a method of providing a cleaned air source to a user includes providing a helmet, the helmet hair an air intake tube, positioning a filter in the air intake tube, and flowing air through the air intake tube. Optionally, the air intake tube connects to the helmet at a first position and the filter is proximate to the first position and the filter position is configured to provide laminar flow to incoming air. Alternatively, the helmet is a racing helmet. In one alternative, the filter incorporates a woven mixture of fiber and particles, resulting in an intermediary material that combines the advantages of both the particle-based and fiber-based filters and has a low pressure drop and high adsorption capacity such that the filter filters for gaseous contaminants. Optionally, the filter is doped with metals/catalysts that can convert NOx to N₂ and the metals/catalysts are selected from a group consisting of copper, platinum, and palladium. In another alternative, the fiber and particles of the woven mixture are directly connected in a linear fashion. Optionally, the method further includes regenerating the filter by applying catalysts that create oxidizing agents when exposed to UV light. In one configuration, the catalysts are TiO₂ and regeneration is completed with 365 nm UV LEDs. In another configuration, a distance between the LEDs and the filter is less than 1 inch for regeneration.

### DETAILED DESCRIPTION

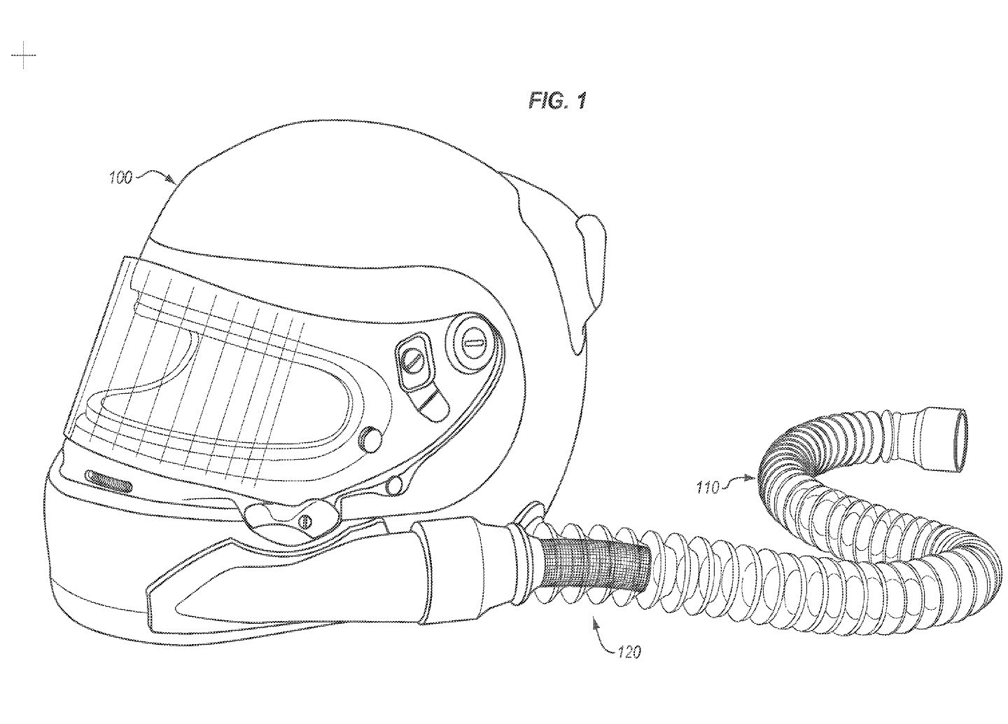

In one embodiment, a carbon-based air filter built into the helmet meets the needs cited above (FIG. 1). Presently, most racecar drivers wear helmets that blow air into a helmet for cooling purposes, but the proximity of this air to the driver's nose and mouth mandates that this air is also the primary source of air for respiration. During the course of a race, a driver is exposed to unburned fuel (hydrocarbons), carbon monoxide, fumes, and harmful gases from a variety of sources. Grand-Am Racing and NASCAR, for example, are endurance races where drivers are in their cars for several hours at a time. The same is true for drivers and passengers during our daily commutes, which is severely worsened from traffic congestion.

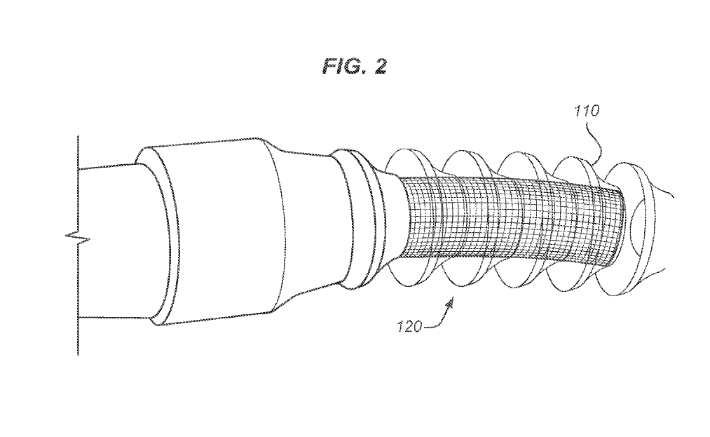

In one embodiment, a helmet includes a compartment for receiving a carbon-based air filter. The compartment is configured to be opened and the filter may be interchanged when its useful life has expired. In one configuration, the compartment is immediately at the end of an air feed tube at the point the tube connects with the helmet. The air feed tube, supplies air to the user, although air may enter the helmet though other apertures. In another configuration, there is no air feed tube, and the filter compartment is located at the primary air aperture, which is located near the mouth of a user utilizing the helmet. One skilled in the art will recognize various placements of the filter exist. In some embodiments the filter may be received by a threading, snap fit, friction fit or other mechanism that secures the filter. In some embodiments, this mechanism may be located directly in the air feed tube. FIG. 1 shows one embodiment of a helmet including air filter. The helmet 100 includes a filter 120 and a ventilation tube 110. FIG. 2 shows a close up of filter 120 and tube 110.

The helmet with ventilation system consists of a carbon-based filter placed in the ducting between the driver's helmet and air intake although one recognizes that other materials that are not-carbon based are suitable for the application. Other adsorbents and/or absorbents that are known to remove volatile organic compounds, synthetic organic compounds, carbon monoxide, sulfur dioxides, and or nitrogen oxides are suited for the application. The exact placement of the filter is best when placed close to the driver's helmet for ease of replacement when the filter is exhausted. Moreover, air flow is more uniform right before the helmet versus other locations in the tubing partially because of a more laminar flow regime versus turbulent air flow regime when the air first enters the tubing.

Some commercially available helmet systems that provide a means to cool the air include a particulate filter (typically at the air point of entry) to remove dust and particles that are microns in size or larger. The filter proposed herein removes gaseous contaminants that are too small to be removed in a particulate filter. The filter herein adsorbs contaminants and serves as a catalyst to convert species, for example, NOx, to more benign compounds. Therefore, the filter may be doped with metals/catalysts that can convert, for example, NOx to N₂ and to remove CO₂. Simple catalysts such as copper, and more advanced catalysts such as platinum or palladium are proposed catalysts.

Most carbon-based gaseous filters are either a fiber mat or are particulate (powdered or granular) based and both work for this application assuming the pressure drop is lower than the available pressure head provided by the fan that moves the air from the point of intake to the helmet. The disadvantage of particulate-based filters (i.e., particles of carbon that are, for example, 45 um or larger) is high pressure drop. The problem with granular based filters can be longer contact times are required. Carbon fiber/mats/or the like overcome the pressure drop concern, but may have much lower capacity for adsorbing compounds (i.e., requires frequent replacement). Instead, the helmet with integrated filter presented herein includes a filter incorporating a woven mixture of fiber and particles, which can provide an intermediary material that combines the advantages of both the particle-based and fiber-based filters. This filter results in a low pressure drop and high adsorption capacity such that a given filter has ample capacity for gaseous contaminants for the duration of a race (e.g., 24 hours or more in some cases). Placing a particulate filter and a fiber filter in series is possible, however, the pressure drop may be far too great thus requiring a larger fan which requires more power (draws more current) and is heavier; both negatives to race and passenger cars. Furthermore, although an alternative configuration would adhere particles to a woven fiber/matt, the particles would overlay the fiber in certain positions and block these pores for removing gaseous compounds. The helmet with filter described herein uses a technique wherein the particles and woven fiber are directly connected linearly (e.g., like a chain) versus one on top of the other. Therefore, the result is a particulate-fiber filter. Synthesis of said filter occurs, for example, through carbon deposition from the cracking of a hydrocarbon at temperatures of 500° C. or higher. Through control of the hydrocarbon, its purity, and temperature solid carbon deposits form that are fibrous, but through small changes in these variables during the continuous production of this fiber particles are formed that are linked (cross-linked) to the carbon fibrous material. The resulting carbon fibrous material therefore consists of a solid fibrous material consisting of mostly carbon fibers, but with solid carbon deposits intermixed throughout the lattice. If desired, the fiber-particle material can be subsequently heated in the presence of, for example, N₂, steam, or carbon dioxide to remove some of the carbon through gasification. The result is a material with a higher surface area, which could be beneficial for contaminant removal. This methodology provides the preferred synthesis technique, but ones skilled in the art will recognize that depositing, for example, activated carbon particles that could be milled to very fine particle sizes (e.g., less than 45 um) and deposited on carbon fiber might provide ample contaminant removal for some applications. Similarly, carbon blocks that are impregnated or not represent possible means to remove undesired compounds.

Although the helmet with filter is targeted towards helmets for racecar applications, the applications extend to other helmets for motorcycles, military applications, mining, and all other applications where a person's head is protected with a helmet. In these applications, the filter may be disposable and replaced with a new filter, but in alternative configurations the filter may be in-situ regenerated if oxidizing agents are embedded within the filter.

Other closed environments may also benefit from clean air. Examples include automobiles, planes, trains, buses, residential homes, commercial buildings, submarines, etc. In these applications, the filter may be replaced or in-situ regenerated. When regeneration is required, catalysts that create oxidizing agents when exposed to UV light would be included. Example catalysts include TiO₂ and regeneration should be completed with 365 nm UV LEDs, which require low power and are lightweight. Furthermore, they are less likely to create, for example, ozone, which is an irritant. The proximity between the LEDs and particle-fiber filter discussed above should be less than 1 inch and more preferably less than one-half inch. One recognizes that other wavelengths of light that are less than and greater than 365 nm could also assist in the regeneration step.

The previous detailed description is of a small number of embodiments for implementing the helmet with filter and is not intended to be limiting in scope. The following claims set forth a number of the embodiments of the helmet and filter system disclosed with greater particularity.

1. A helmet with integrated filter comprising:
a helmet;
a filter, integrated with the helmet, incorporating a woven mixture of fiber and particles, resulting in an intermediary material that combines the advantages of both the particle-based and fiber-based filters and has a low pressure drop and high adsorption capacity such that the filter captures gaseous contaminants.

2. The helmet of claim 1, wherein the filter is located right before the helmet as compared to other locations in tubing leading to the helmet resulting in more uniform air flow because of a more laminar flow regime versus turbulent air flow regime when air first enters the tubing.

3. The helmet of claim 1, wherein the filter is doped with metals/catalysts that can convert NOx to N₂ and wherein the metals/catalysts are selected from a group consisting of copper, platinum, and palladium.

4. The helmet of claim 1, wherein the fiber and particles of the woven mixture are directly connected linearly.

5. The helmet of claim 1, wherein the filter is configured to be regenerated by catalysts that create oxidizing agents when exposed to UV light.

6. The helmet of claim 5, wherein the catalysts are TiO₂ and regeneration is completed with 365 nm UV LEDs.

7. The helmet of claim 6, wherein a distance between the LEDs and the filter is less than 1 inch for regeneration.

8. A breathing system with integrated filter, comprising:
a helmet;
an air intake tube attached to the helmet; and
a filter located in the air intake tube, the filter configured to remove impurities in air.

9. The breathing system of claim 8, wherein the air intake tube connects to the helmet at a first position and the filter is proximate to the first position.

10. The breathing system of claim 9, wherein the filter position is configured to provide laminar flow to incoming air.

11. The breathing system of claim 8, wherein the helmet is a racing helmet.

12. The breathing system of claim 8, wherein the filter incorporates a woven mixture of fiber and particles, resulting in an intermediary material that combines the advantages of both the particle-based and fiber-based filters and has a low pressure drop and high adsorption capacity such that the filter filters for gaseous contaminants

13. The breathing system of claim 12, wherein the filter is doped with metals/catalysts that can convert NOx to N₂ and the metals/catalysts are selected from a group consisting of copper, platinum, and palladium.

14. The breathing system of claim 12, wherein the fiber and particles of the woven mixture are directly connected in a linear fashion.

15. The breathing system of claim 12, wherein the filter is configured to be regenerated by catalysts that create oxidizing agents when exposed to UV light.

16. The breathing system of claim 15, wherein the catalysts are TiO₂ and regeneration is completed with 365 nm UV LEDs.

17. The breathing system of claim 16, a distance between the LEDs and the filter is less than 1 inch for regeneration.

18. A method of providing a cleaned air source to a user comprising:
providing a helmet, the helmet hair an air intake tube,
positioning a filter in the air intake tube, and
flowing air through the air intake tube.

19. The method of claim 18, wherein the air intake tube connects to the helmet at a first position and the filter is proximate to the first position and the filter position is configured to provide laminar flow to incoming air.

20. The method of claim 18, wherein the helmet is a racing helmet.

21. The method of claim 18, the filter incorporates a woven mixture of fiber and particles, resulting in an intermediary material that combines the advantages of both the particle-based and fiber-based filters and has a low pressure drop and high adsorption capacity such that the filter filters for gaseous contaminants.

22. The method of claim 21, wherein the filter is doped with metals/catalysts that can convert NOx to N₂ and the metals/catalysts are selected from a group consisting of copper, platinum, and palladium.

23. The method of claim 21, wherein the fiber and particles of the woven mixture are directly connected in a linear fashion.

24. The method of claim 21, further comprising: regenerating the filter by applying catalysts that create oxidizing agents when exposed to UV light.

25. The method of claim 24, wherein the catalysts are TiO₂ and regeneration is completed with 365 nm UV LEDs.

26. The method of claim 25, wherein a distance between the LEDs and the filter is less than 1 inch for regeneration.
